(19) United States
(12) Patent Application Publication
(10) Pub. No.: US 2011/0089279 A1
(43) Pub. Date: Apr. 21, 2011

(54) GRANULATOR HOUSING AND A METHOD FOR MOUNTING/DISMOUNTING A KNIFE THEREIN

(75) Inventors: Henrik Karlsson, Varnamo (SE); Kurt Sjöberg, Bredaryd (SE); Ulf Henning, Varnamo (SE)

(73) Assignee: RAPID GRANULATOR AB, Bredaryd (SE)

(21) Appl. No.: 12/996,882

(22) PCT Filed: Jun. 30, 2009
(86) PCT No.: PCT/SE09/00342

§ 371 Date: Dec. 8, 2010

(30) Foreign Application Priority Data
Jul. 9, 2008 (SE) 0801650-3

(51) Int. Cl. B02C 17/20; B23P 11/00

(52) U.S. Cl. 241/277; 29/428

(57) ABSTRACT

A granulator mill housing for a granulator mill has a rotor, provided with knives, journalled therein, and seats against which fixed knives may be fixedly clamped by means of screws and guide bars. At a lower seat, there is a stand on which a guide bar is placeable in a preparatory position. The side of the guide bar, intended for cooperation with the knife is turned upwards. Pivoting of the guide bar and the knife will move the knife into abutment with the seat. On mounting of a knife against a seat in a granulator mill housing, the knife and a guide bar are screwed in position against the seat. First the guide bar is placed on a stand, whereafter the knife is placed on the guide bar, and the guide bar and the knife are pivoted together to a mounting position with the knife in abutment against the seat where screws are mounted.

### BACKGROUND AND SUMMARY

The present invention relates to a granulator mill housing for a granulator, comprising a rotor space in which a rotor fitted with knives is rotatably mounted, and a number of seats against which fixed knives may he clamped by means of screws and guide bars.

The present invention also relates to a method of mounting a knife against a seat in a granulator mill housing, the knife and a guide bar supporting the knife being screwed in position against the seat.

Granulator mill housings for granulators for use within the plastics industry are previously known in the art. Such granulator mill housings display as a rule a plurality of fixed knives for cooperation with corresponding knives on a rotor accommodated in the granulator mill housing. The fixed knives are generally screwed in position against seats in the granulator mill housing with the aid of screws and guide bars so that the knives are fixedly clamped between the guide bars and the seats of the granulator mill housing.

Granulators are manufactured in a plurality of different sizes, in which event—as regards larger granulators—both the guide bars and the knives will have considerable dimensions and as a result substantial weight, often together of the order of magnitude of between 20 and 30 kg. If a knife is difficult to access, for example on the underside of the granulator mill housing, it is almost impossible to mount such a knife in position for a single person. The reason for this is that it would entail that this person must handle two separate parts of considerable weight and manoeuvre them to the correct position so that the screws may be mounted in place.

It is desirable to design the granulator mill housing disclosed by way of introduction so that the drawbacks inherent in the prior art are obviated. In particular, it is desirable to design the granulator mill housing so that its knives and guide bars may simply and conveniently be mounted and dismounted by a single person.

It is also desirable to design the method disclosed by way of introduction so that the drawbacks inherent in the prior art technology are obviated. In particular, it is desirable to design the method so that the knives and guide bars may be mounted simply and conveniently by a single person.

A granulator mill housing according to an aspect of the present invention is characterised in that one of the seats is disposed at the underside of the granulator mill housing, that, in the area of this seat, there is provided a stand on which a guide bar may be laid in a preparatory position with its side intended for cooperation with a knife turned to face substantially upwards, and that the guide bar and knife resting thereon are together pivotal to a mounting position with the knife in abutment against the seat.

A method according to an aspect of the present invention is characterised in that the guide bar is placed on a stand in the region of the seat and is turned with its side intended for cooperation with the knife facing upwards, possibly with a knife already resting thereon, that, where applicable, the knife is placed on the surface of the guide bar intended for cooperation with the knife and that the guide bar and the knife, together and resting on the stand, are pivoted to a mounting position with the knife in abutment against the seat, and that the screws are mounted in position.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a vertical side elevation of a granulator mill housing, where an opening hatch has been removed;

FIG. 2 is a view taken along the line A-A in FIG. 1;

FIG. 3 is a perspective view of a part of the granulator mill housing according to the present invention;

FIG. 4 is an end elevation of a part in the granulator mill housing and with a guide bar and a knife in the mounted position;

FIG. 5 is a view corresponding to that of FIG. 4 with the knife and the guide bar in a preparatory position;

FIG. 6 is a view corresponding to that of FIGS. 4 and 5 with the knife lifted away from the guide bar; and

FIG. 7 is a view corresponding to that of FIGS. 4-6 with the guide bar lifted away.

### DETAILED DESCRIPTION

To the extent directional- and positional disclosures are used in the following description, these refer to directions and positions in the normal position of use of the granulator mill housing.

The granulator mill housing according to the present invention is principally intended for large granulators, where the distance between two end walls I included in the granulator mill housing may amount to more than 1 m. The end walls 1 have bearing housings 2 for journaling a rotor 4 in a rotor space 3 interiorly in the granulator mill housing.

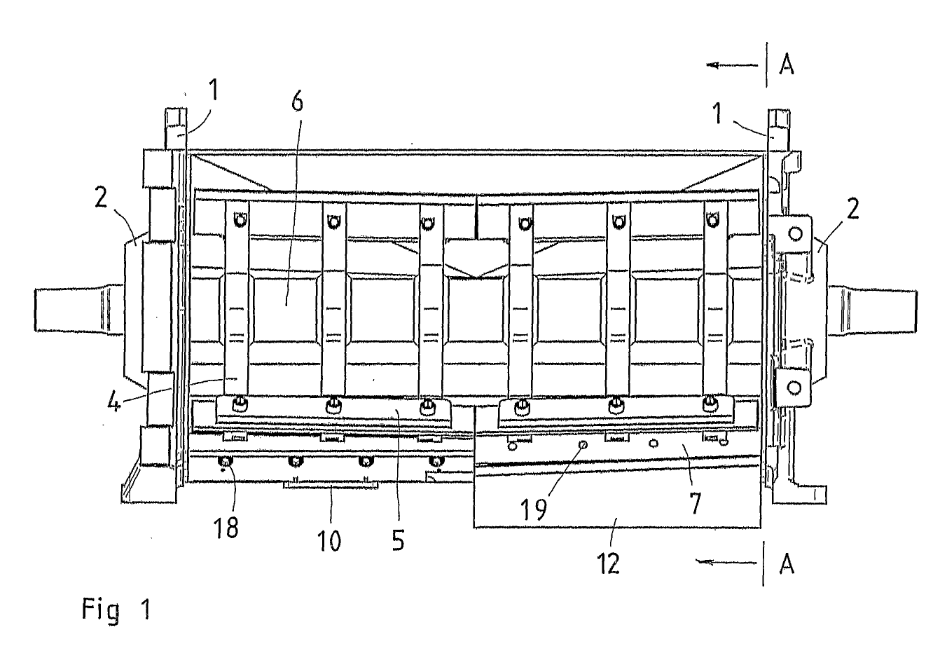

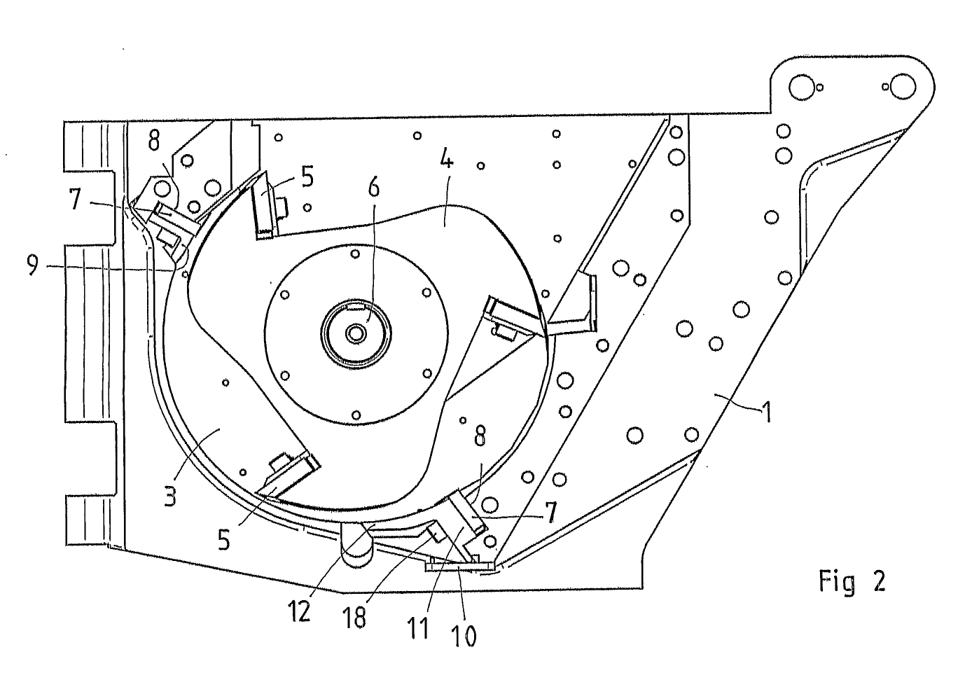

It will be apparent from FIGS. 1 and 2 taken together that the rotor 4 disposed in the rotor space 3 has three knives 5 disposed at the periphery of the rotor. It will further be apparent that the rotor 4 has a shaft 6 which is journalled in the above mentioned bearing housings 2.

The granulator mill housing has, in the illustrated embodiment, three fixed knives 7 which are fixedly clamped against corresponding seats 8 in the granulator mill housing with the aid of guide bars 9.

The continued description hereinbelow will be restricted to the knife placed on the underside of the granulator mill housing and its associated guide bar.

In the area of the knife placed at the underside of the granulator mill housing, there is provided a stand 10 in the form of a shelf or a plate which has a substantially horizontally aligned upper surface. The stand extends out from the wall of the granulator mill housing and is fixed thereto so that a free space is formed on the upper side of the stand.

The guide bar 9 has an elongate main portion 11 which has a surface 13 intended for cooperation with the knife 7. The guide bar further displays a wall portion 12 which, in the mounted position of the guide bar, forms a part of that defining wall which surrounds the rotor space 3. The free edge of the wall portion 12 facing away from the main portion 11 of the guide bar is, in the mounted position, located substantially straight beneath the rotational shaft 6 of the rotor 4.

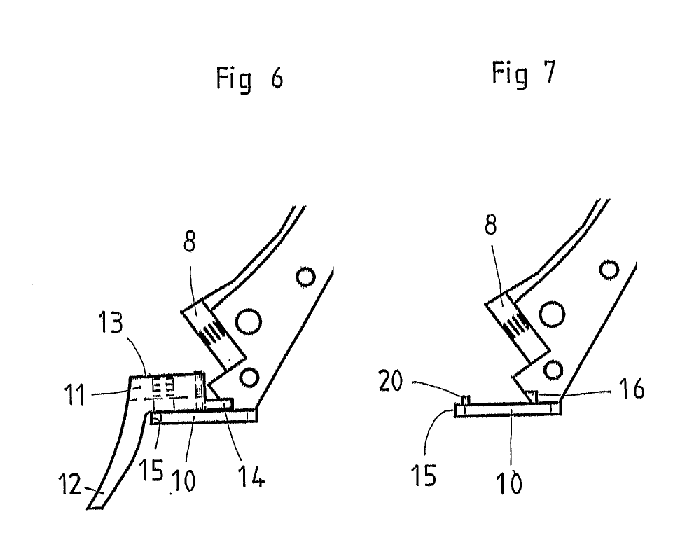

As is best apparent from FIGS. 5 and 6, the major portion 11 of the guide bar may be laid on the upper side of the stand 10 with the surface 13 intended for cooperation with the knife turned to face upwards. The major portion displays, along its longitudinal side facing away from the wall portion 12, a projecting bead 14 which may be accommodated in a corresponding groove 16 on the upper side of the stand 10. With the present design of the guide bar, its point of gravity would be located outside the free edge 15 of the stand, and so the guide bar would fall down from the stand if the bead 14 were not accommodated in the recess 16, which is closed upwards.

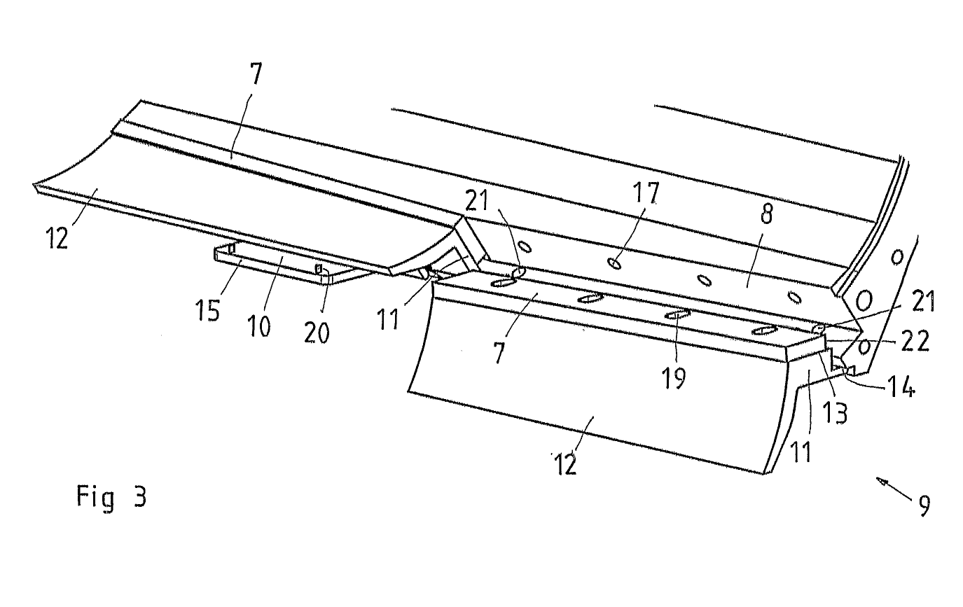

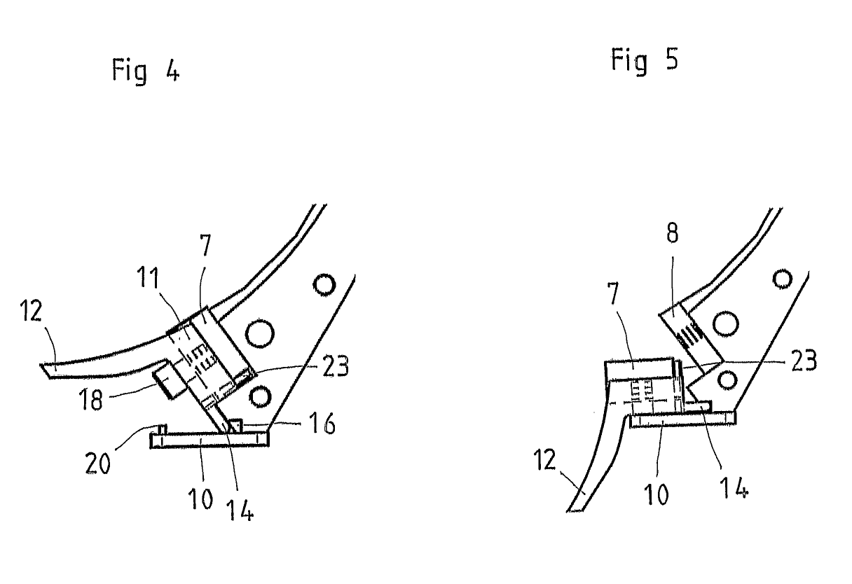

As is apparent from FIG. 3, the seat 8 displays a number of threaded bores 17 for accommodating the screws 18 which are employed for fixedly screwing both the guide bar and the knife 7 cooperating therewith. It will be apparent from FIG. 3 that the knife 7 has apertures 19 for these screws 18. Corresponding apertures are also provided in the main portion 11 of the guide bar.

It will be apparent from the figures that, on the upper side of the stand 10, there is provided at least one, but preferably two upwardly directed pins 20. These pins 20 fit into the two centrally located apertures in the major portion 11 of the guide bar and thereby prevent relative slipping between the guide bar and the stand 10 when the guide bar is laid on the upper side of the stand.

As was mentioned above, the guide bar may simply be lifted in and placed on the stand 10 as shown in the right-hand half of FIG. 3. In this position, the guide bar is in a preparatory position where a knife 7 may readily be placed on its upper side. Transfer of the guide bar and the knife to a mounting position, where the knife abuts against the seat 8, is simply realised by pivoting of the guide bar and the knife together along a pivot axis which is defined by the free longitudinal edge of the bead 14. After such a pivoting, the weight of both the knife and the guide bar still rests on the stand 10, and so the guide bar and the knife can simply be held fast in this position using only one hand. Thus, one hand is left free for mounting the screws 18 which are used for fixedly screwing the guide bar and the knife in position, the screws being positionable in the threaded bores 17 of the seat 8.

On dismounting of a knife, the screws 18 are first backed off, whereafter the knife and the guide bar are pivoted from the mounting position to the preparatory position, their weight still being taken up by the stand 10. In the final phase of this pivoting, the pins 20 will he accommodated in the two centrally located apertures in the main portion 11 of the guide bar so that slipping is prevented. At the same time, the bead 14 will be accommodated in the recess 16 and abut against its upper defining wall. This implies that the guide bar and the knife 7 rest in a stable position on the upper side of the stand 10. From this position, the knife can then be lifted down simply, as also applies to the guide bar 9.

For adjustment of the knife 7 in the radial direction, i.e. the distance between the edge of the knife and the edges of the knives 5 disposed on the rotor 4, there are provided set screws 22 at the seat 8 (FIG. 3), the set screws being given permanent adjustment and fixed in the seat. The set screws 21 principally serve the purpose of compensating for such tolerances as the granulator mill housing may have.

In the rear edge 22 of the knife, there are provided adjustment screws 23 which are adjusted in connection with grinding of the knife and which are placed for cooperation with the end surfaces of the set screws 21. The adjustment screws thus serve the purpose of compensating for such dimensional changes as occur on regrinding of a knife.

When a guide bar and a fixed knife resting thereon are pivoted from the preparatory position to the mounting position, there may be a certain risk that the adjustment screws 23 and the set screws 21 catch in one another so that the pivoting is obstructed or the knife 7 comes out of position. In order to avoid this risk, there are small heels provided on the surface 13 of the guide bar intended for cooperation with the knife, the heels preventing the knife 7 from sliding down before time against the set screws 21.

1. A granulator mill housing for a granulator, comprising a rotor space in which a rotor provided with knives is rotatably journalled, and a number of seats against which fixed knives may be fixedly clamped by means of screws and guide bars, wherein one of the seats is disposed at the under side of the granulator mill housing, that, in the region of this seat there is provided a stand on which a guide bar may be placeable in a preparatory position with its side intended for the cooperation with the knife turned to face substantially upwards, and the guide bar and the knife resting thereon are together pivotal to a mounting position with the knife in abutment against the seat.

2. The granulator mill housing as claimed in claim 1, wherein the guide bar has a longitudinal, projecting bead which, in the preparatory position, rests on the stand and whose free longitudinal edge makes a pivot axis, about which the guide bar moves on pivoting from the preparatory position to the mounting position, and vice versa.

3. The granulator mill housing as claimed in claim 2, wherein there is disposed, on the upper side of the stand, an elongate upwardly defined recess in which the projecting bead of the guide bar is located in the preparatory position.

4. The granulator mill housing as claimed in claim 2, wherein the guide bar has an outer surface in relation to the rotor space which is substantially parallel with the surface of the guide bar intended for abutment against the knife, and the bead constitutes a part of this surface.

5. The granulator mill housing as claimed in claim 1, wherein the guide bar has through-going apertures for those screws by means of which the guide bar and the knife are fixed against the seat, and the stand has a number of upwardly projecting pins which may be accommodated in one or more of the apertures of the guide bar in the preparatory position in order thereby to prevent sliding of the guide bar on the stand.

6. The granulator mill housing as claimed in claim 1, wherein the guide bar has a longitudinal wall portion along its edge facing away from the knife, that this wall portion, in the mounting position, constitutes a part of the lower defining wall of the rotor space, and, in the preparatory position, it extends downwards outside the free edge of the stand.

7. The granulator mill housing as claimed in claim 6, wherein a free edge of the longitudinal wall portion of the guide bar is, in the mounting position, located substantially straight beneath the rotational shaft (6) of the rotor.

8. The granulator mill housing as claimed in claim 1, wherein the guide bar in the preparatory position extends out on both sides of the stand outside it.

9. A method of mounting a knife against a seat in a granulator mill housing, the knife and a guide bar supporting the knife being screwed in position against the seat, wherein the guide bar is placed on a stand in the region of the seat and is turned to face with its side intended for cooperation with the knife turned to face upwards, and the knife is placed on the surface of the guide bar intended for cooperation with the knife, and the guide bar and the knife together and resting on the stand are pivoted to a mounting position with the knife in abutment against the seat, and the screws are mounted in position.

10. A method of dismounting a knife from a seat in a granulator mill housing, fixing screws for the knife and a guide bar supporting the knife being backed off, wherein the guide bar and the knife together and resting on a stand are pivoted to a preparatory position, the surface of the guide bar intended for cooperation with the knife being turned to face upwards and the guide bar and the knife being supported by the stand and the knife and the guide bar are removed from the stand.
